(19) United States
(12) Patent Application Publication
(10) Pub. No.: US 2026/0125805 A1
(43) Pub. Date: May 7, 2026

(54) MEMBRANE ELECTRODE ASSEMBLY FOR WATER ELECTROLYSIS AND METHOD FOR MANUFACTURING THE SAME

(71) Applicant: TOYOTA JIDOSHA KABUSHIKI KAISHA, Toyota-shi (JP)

(72) Inventors: Tomoki KODAMA, Toyota-shi (JP); Yasuhiro AKITA, Nagoya-shi (JP)

(73) Assignee: TOYOTA JIDOSHA KABUSHIKI KAISHA, Toyota-shi (JP)

(21) Appl. No.: 19/262,420

(22) Filed: Jul. 8, 2025

(30) Foreign Application Priority Data
Nov. 6, 2024 (JP) 2024-194130

(51) Int. Cl. C25B 9/23; B32B 27/08; B32B 27/20; B32B 37/06; B32B 37/20

(52) U.S. Cl. CPC C25B 9/23; B32B 27/08; B32B 27/20; B32B 37/06; B32B 37/203; B32B 2250/40; B32B 2255/10; B32B 2255/20; B32B 2264/105; B32B 2309/02; B32B 2311/06; B32B 2457/00

(57) ABSTRACT

A membrane electrode assembly for water electrolysis includes a solid electrolyte membrane, and an anode catalyst layer and a cathode catalyst layer that sandwich the solid electrolyte membrane. The solid electrolyte membrane includes a solid electrolyte layer, and a functional layer provided on an anode-side surface of the solid electrolyte layer. The anode catalyst layer is provided on a surface of the solid electrolyte membrane near the functional layer. The cathode catalyst layer is provided on a surface of the solid electrolyte membrane opposite to the functional layer. The functional layer contains a resin and catalytic metal particles dispersed in the resin.

### CROSS-REFERENCE TO RELATED APPLICATION

This application claims priority to Japanese Patent Application No. 2024-194130 filed on Nov. 6, 2024. The disclosure of the above-identified application, including the specification, drawings, and claims, is incorporated by reference herein in its entirety.

### BACKGROUND

### 1. Technical Field

The present disclosure relates to a membrane electrode assembly for water electrolysis to be used in a water electrolysis device, and a method for manufacturing the membrane electrode assembly for water electrolysis.

### 2. Description of Related Art

In recent years, water electrolysis devices in which a predetermined number of water electrolysis cells using solid electrolyte membranes are arranged have been adopted. Such a water electrolysis cell includes a membrane electrode assembly including a solid electrolyte membrane and an anode catalyst layer and a cathode catalyst layer that sandwich the solid electrolyte membrane. As the membrane electrode assembly for water electrolysis, for example, there is known a membrane electrode assembly in which a catalyst layer is formed using a catalyst layer forming material containing catalyst particles and an electrolyte component as main components, and the catalyst particles and the electrolyte component that form the catalyst layer have a gradient in distribution such that the electrolyte component in the catalyst layer is not unevenly distributed in the vicinity of the surface of the catalyst layer (Japanese Unexamined Patent Application Publication No. 2001-303285 (JP 2001-303285 A)). As a method for manufacturing the membrane electrode assembly for water electrolysis, for example, there is disclosed a method including: a first forming step of forming either an anode catalyst layer or a cathode catalyst layer on a second surface opposite to a first surface of an elongated electrolyte membrane, with a support film that holds the electrolyte membrane in a stretched state being attached to the first surface; a first attaching step of peeling a support member from the first surface of the electrolyte membrane and attaching, to the second surface, a diffusion member that constitutes a diffusion layer for diffusing a fluid that constitutes fuel or an oxidant required for electrochemical reaction in a fuel cell; a second forming step of forming the other catalyst layer on the first surface; and a second attaching step of attaching the diffusion member to the first surface. The method is performed by a roll-to-roll process (Japanese Unexamined Patent Application Publication No. 2015-35256 (JP 2015-35256 A)).

### SUMMARY

In the membrane electrode assembly for water electrolysis and the manufacturing method according to the related art, the composition of and the formation method for the catalyst layer have been improved to improve the water electrolysis performance of the water electrolysis cell. To ensure the safety of the water electrolysis cell, it is necessary to suppress generation of explosive oxyhydrogen gas by blocking permeation of hydrogen gas generated on the cathode side through the solid electrolyte membrane. There is a demand to improve the blocking performance against the permeation of hydrogen gas through the solid electrolyte membrane.

The present disclosure has been made in view of the above circumstances, and an object of the present disclosure is to provide a membrane electrode assembly for water electrolysis that can improve blocking performance against permeation of hydrogen gas through a solid electrolyte membrane, and to provide a method for manufacturing the membrane electrode assembly for water electrolysis.

In order to solve the above problem, a membrane electrode assembly according to the present disclosure is a membrane electrode assembly for water electrolysis. The membrane electrode assembly includes a solid electrolyte membrane, and an anode catalyst layer and a cathode catalyst layer that sandwich the solid electrolyte membrane. The solid electrolyte membrane includes a solid electrolyte layer, and a functional layer provided on an anode-side surface of the solid electrolyte layer. The anode catalyst layer is provided on a surface of the solid electrolyte membrane near the functional layer. The cathode catalyst layer is provided on a surface of the solid electrolyte membrane opposite to the functional layer. The functional layer contains a resin and catalytic metal particles dispersed in the resin.

A method for manufacturing a membrane electrode assembly according to the present disclosure is a method for manufacturing a membrane electrode assembly for water electrolysis. The method includes: preparing an electrolyte membrane sheet including an existing back sheet (sometimes abbreviated as “BS”) and a solid electrolyte membrane attached to the existing back sheet, the solid electrolyte membrane including a solid electrolyte layer and a functional layer provided on a surface of the solid electrolyte layer opposite to the existing back sheet; attaching a fresh back sheet to a surface of the solid electrolyte membrane near the functional layer through thermocompression bonding by laminating the electrolyte membrane sheet and the fresh back sheet to form a laminate such that the fresh back sheet is in contact with the surface of the solid electrolyte membrane near the functional layer, and heating the laminate while pressurizing the laminate from both sides in a laminating direction; peeling the existing back sheet from the solid electrolyte membrane; forming a cathode catalyst layer on a surface of the solid electrolyte membrane opposite to the functional layer after the peeling of the existing back sheet; peeling the fresh back sheet from the solid electrolyte membrane after the forming of the cathode catalyst layer; and forming an anode catalyst layer on the surface of the solid electrolyte membrane near the functional layer after the peeling of the fresh back sheet.

According to the present disclosure, it is possible to improve the blocking performance against the permeation of hydrogen gas through the solid electrolyte membrane.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a sectional view schematically showing a membrane electrode assembly for water electrolysis (WE) according to one embodiment;

FIG. 1B is an exploded sectional view schematically showing a water electrolysis device according to the embodiment;

FIG. 2A is a sectional view schematically showing a membrane electrode assembly for WE according to related art;

FIG. 2B is an exploded sectional view schematically showing a water electrolysis device according to the related art;

FIG. 3 is a flowchart showing an outline of a mixed production method for implementing a method for manufacturing the membrane electrode assembly for WE according to the embodiment;

FIG. 4 is a sectional view schematically showing a manufacturing line for implementing the method for manufacturing the membrane electrode assembly for WE according to the embodiment, in which devices on a manufacturing line MF shown in FIG. 4 operate under control of a control device CR;

FIG. 5A is a graph showing the amounts of hydrogen in gas generated on an anode side in water electrolysis experiments using water electrolysis cells fabricated from membrane electrode assemblies of Example and Comparative Examples 1 and 2, in which the amounts of hydrogen are each expressed by a normalized value with the amount of hydrogen in the gas generated on the anode side in the water electrolysis experiment of Comparative Example 2 being taken as a reference value “1”;

FIG. 5B is a graph showing a hydrogen permeability at each relative humidity for a single piece of a solid electrolyte membrane prepared for the membrane electrode assembly of each of Example and Comparative Example 1 and a solid electrolyte membrane prepared for the membrane electrode assembly of Comparative Example 2;

FIG. 6A is a graph showing peel strengths [N/m] of fresh BSs of Reference Examples 1 to 10, and also showing a peel strength [N/m] of an existing BS that is obtained by conducting a 90-degree peel test to peel the existing BS from solid electrolyte membranes of electrolyte membrane sheets prepared in Reference Examples 1 to 10; and

FIG. 6B is a diagram showing photographs of existing BS peeled sheet samples of Reference Examples 5 to 8 that are taken from the fresh BS side after an elapse of 20 minutes from dropping of a mixed solvent, and a photograph of an existing BS peeled sheet sample of Reference Example 1 that is taken from the fresh BS side after an elapse of 15 minutes from dropping of a mixed solvent, and also showing, at the left end, a reference photograph of an electrolyte membrane sheet sample taken from the existing BS side after an elapse of 20 minutes from dropping of a similar mixed solvent.

### DETAILED DESCRIPTION OF EMBODIMENTS

Hereinafter, embodiments of a membrane electrode assembly for water electrolysis and a method for manufacturing the membrane electrode assembly for water electrolysis according to the present disclosure will be described. Hereinafter, water electrolysis may be abbreviated as “WE.”

### A. Embodiment of Membrane Electrode Assembly for WE According to Present Disclosure

First, the embodiment of the membrane electrode assembly for WE according to the present disclosure will be described based on one exemplary embodiment.

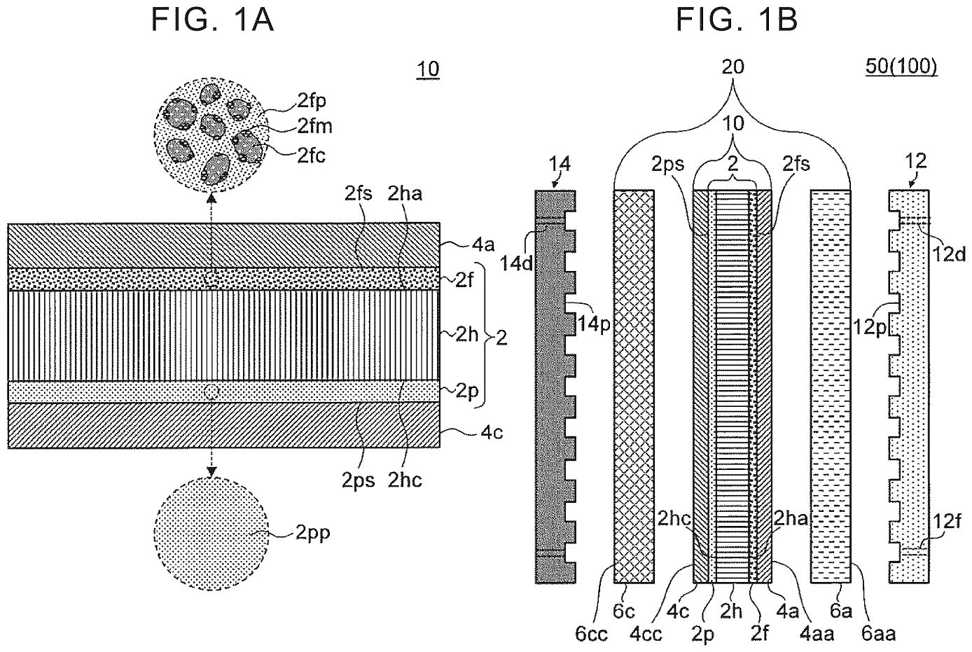

As shown in FIG. 1A, a membrane electrode assembly 10 for WE according to the embodiment includes a solid electrolyte membrane 2 and an anode catalyst layer 4a and a cathode catalyst layer 4c that sandwich the solid electrolyte membrane 2. The solid electrolyte membrane 2 includes a solid electrolyte layer 2h, and a functional layer 2f and a resin layer 2p formed on an anode-side surface 2ha and a cathode-side surface 2hc of the solid electrolyte layer 2h, respectively. The anode catalyst layer 4a is formed on a surface 2fs of the solid electrolyte membrane 2 near the functional layer, and the cathode catalyst layer 4c is formed on a surface 2ps of the solid electrolyte membrane 2 near the resin layer (surface opposite to the functional layer). The functional layer 2f contains a resin 2fp, supports 2fc dispersed in the resin 2fp, and catalytic metal particles 2fm supported on the supports 2fc. The resin layer 2p contains a resin 2pp.

As shown in FIG. 1B, a water electrolysis device 100 according to the embodiment is constructed by laminating a plurality of WE cells 50. The WE cell 50 is a solid polymer WE cell including a membrane electrode gas diffusion layer assembly 20 for WE, and an anode-side separator 12 and a cathode-side separator 14 that sandwich the membrane electrode gas diffusion layer assembly 20. The membrane electrode gas diffusion layer assembly 20 includes the membrane electrode assembly 10 for WE according to the embodiment, and an anode-side gas diffusion layer (sometimes abbreviated as “anode-side GDL”) 6a and a cathode-side gas diffusion layer (sometimes abbreviated as “cathode-side GDL”) 6c that sandwich the membrane electrode assembly 10. In the membrane electrode gas diffusion layer assembly 20, the anode-side GDL 6a is laminated on a surface 4aa of the anode catalyst layer 4a opposite to the solid electrolyte membrane, and the cathode-side GDL 6c is laminated on a surface 4cc of the cathode catalyst layer 4c opposite to the solid electrolyte membrane. In the WE cell 50, the anode-side separator 12 is laminated on a surface 6aa of the anode-side GDL 6a opposite to the membrane electrode assembly, and the cathode-side separator 14 is laminated on a surface 6cc of the cathode-side GDL 6c opposite to the membrane electrode assembly.

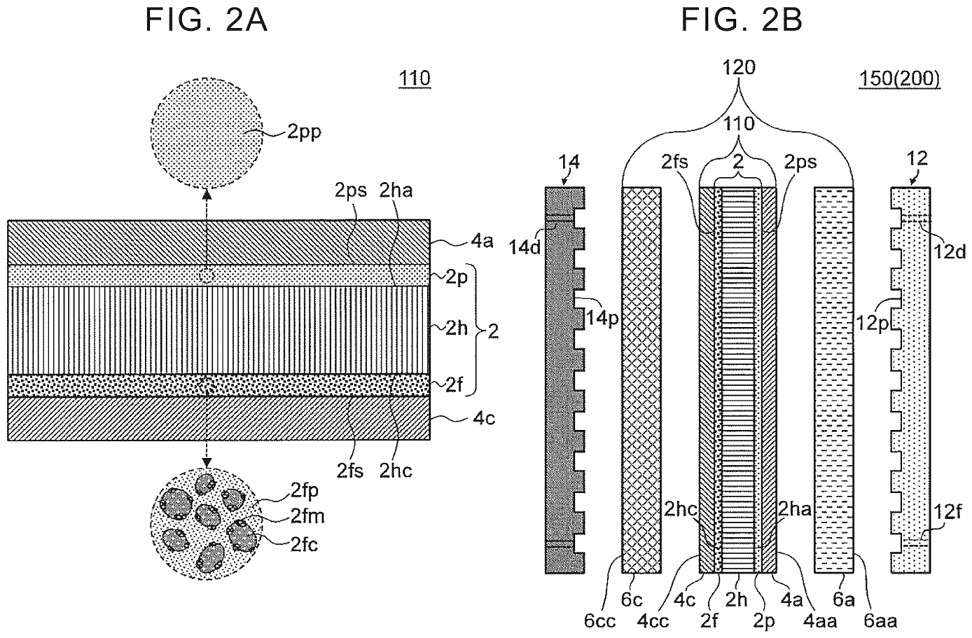

As shown in FIG. 2A, a membrane electrode assembly 110 for WE according to related art is similar to the membrane electrode assembly 10 according to the embodiment, except that the functional layer 2f and the resin layer 2p of the solid electrolyte membrane 2 are formed on the cathode-side surface 2hc and the anode-side surface 2ha of the solid electrolyte layer 2h, respectively, and that the anode catalyst layer 4a and the cathode catalyst layer 4c are formed on the surface 2ps of the solid electrolyte membrane 2 near the resin layer (surface opposite to the functional layer) and the surface 2fs of the solid electrolyte membrane 2 near the functional layer, respectively. As shown in FIG. 2B, a water electrolysis device 200 (WE cell 150) according to the related art is similar to the water electrolysis device 100 according to the embodiment, except that a membrane electrode gas diffusion layer assembly 120 includes the membrane electrode assembly 110 according to the related art instead of the membrane electrode assembly 10 according to the embodiment.

Effects of the membrane electrode assembly 10 for WE according to the embodiment will be described in comparison with the related art. When hydrogen gas is produced by electrolyzing raw water using the water electrolysis device that uses the membrane electrode assembly, the raw water is first supplied to a fluid passage 12p from a water supply port 12f in the anode-side separator 12, and electricity is simultaneously transmitted to the anode catalyst layer 4a and the cathode catalyst layer 4c by the anode-side separator 12 and the cathode-side separator 14, respectively. Therefore, the raw water is electrolyzed in the anode catalyst layer 4a, and hydrogen ions (H⁺), electrons, and oxygen gas (O₂) are generated. The oxygen gas is discharged from a water drain port 12d together with the majority of the raw water. Next, the hydrogen ions permeate the solid electrolyte membrane 2 due to the potential difference, and migrate from the anode catalyst layer 4a toward the cathode catalyst layer 4c. Next, the hydrogen ions receive electrons at the cathode catalyst layer 4c, and hydrogen gas (H₂) is generated. The generated hydrogen gas passes through a fluid passage 14p of the cathode-side separator 14 and is taken out from a hydrogen outlet 14d. The hydrogen gas has high pressure. Therefore, in the water electrolysis device 200 using the membrane electrode assembly 110 according to the related art, the hydrogen gas may permeate the solid electrolyte membrane 2 and flow back to the fluid passage 12p of the anode-side separator 12 due to the pressure difference. When the back-flowing hydrogen gas is mixed with the oxygen gas, explosive oxyhydrogen gas is generated, which may cause a safety problem. In the water electrolysis device 100 using the membrane electrode assembly 10 according to the embodiment, the anode catalyst layer 4a is adjacent to the functional layer 2f of the solid electrolyte membrane 2. Therefore, it is considered that an interaction occurs between the catalyst in the anode catalyst layer 4a and the functional layer 2f. For this reason, it is considered that, when the hydrogen gas is to permeate the solid electrolyte membrane 2 and flow back to the fluid passage 12p of the anode-side separator 12, the hydrogen gas can be converted into hydrogen ions by the interaction inside the solid electrolyte membrane and at the interface between the solid electrolyte membrane 2 and the anode catalyst layer 4a and the hydrogen ions can be migrated again to the cathode side via the solid electrolyte membrane 2, or the hydrogen gas can be converted into water and the water can be drained from the water drain port 12d. This improves the blocking performance against the permeation of the hydrogen gas through the solid electrolyte membrane 2, thereby suppressing the generation of explosive oxyhydrogen gas.

Hereinafter, the embodiment of the membrane electrode assembly for WE according to the present disclosure will further be described.

The solid electrolyte layer of the solid electrolyte membrane is not particularly limited as long as it contains a proton-conductive solid polymer material (electrolyte), and examples thereof include an ion exchange layer containing a solid polymer material. Examples of the solid polymer material contained in the ion exchange layer include a fluorine resin (e.g., a perfluoro-based electrolyte) and a hydrocarbon resin. The functional layer of the solid electrolyte membrane is not particularly limited, and examples thereof include a functional layer containing a resin, supports dispersed in the resin, and catalytic metal particles supported on the supports. The resin is not particularly limited, and examples thereof include a resin containing a proton-conductive solid polymer material. Examples of the solid polymer material include a fluorine resin (e.g., a perfluoro-based electrolyte) and a hydrocarbon resin. Examples of the catalytic metal contained in the catalytic metal particles include one or more kinds selected from the group consisting of Pt (platinum), Au (gold), Pd (palladium), Rh (rhodium), and Ir (iridium). Examples of the support include a carbon support such as carbon black.

The solid electrolyte membrane is not particularly limited, and may further include, for example, a resin layer formed on the cathode-side surface of the solid electrolyte layer. The resin layer of the solid electrolyte membrane is not particularly limited as long as it contains a resin containing, for example, a proton-conductive solid polymer material. Examples of the solid polymer material contained in the resin layer include a fluorine resin (e.g., a perfluoro-based electrolyte) and a hydrocarbon resin.

The anode catalyst layer is not particularly limited as long as it contains a catalyst that contains a catalytic component that exhibits a catalytic action by a reaction (2H₂O→O₂+4H⁺+4e⁻) in the anode catalyst layer, and may be, for example, a layer containing a catalyst that contains a support and a catalytic component supported on the support. Examples of the catalytic component include one or more kinds selected from the group consisting of precious metals (e.g., Pt, Ru, and Ir) and oxides of the precious metals. Specific examples include Pt, an iridium oxide, a ruthenium oxide, an iridium ruthenium oxide, and mixtures thereof. Examples of the iridium oxide include an iridium oxide (e.g., IrO₂ or IrO₃), an iridium tin oxide, and an iridium zirconium oxide. Examples of the ruthenium oxide include a ruthenium oxide (e.g., RuO₂ or Ru₂O₃), a ruthenium tantalum oxide, a ruthenium zirconium oxide, a ruthenium titanium oxide, and a ruthenium titanium cerium oxide. Examples of the iridium ruthenium oxide include an iridium ruthenium cobalt oxide, an iridium ruthenium tin oxide, an iridium ruthenium iron oxide, and an iridium ruthenium nickel oxide. Examples of the support include a titanium oxide, a manganese oxide, and a cobalt oxide. The anode catalyst layer is preferably a layer that contains an ionomer in addition to the catalyst and in which the catalyst is coated with the ionomer. This is because the coatability can be improved and the hydrophilicity of the ionomer enables smooth permeation of the raw water. Examples of the ionomer include an ionomer containing the perfluoro-based electrolyte for use in the solid electrolyte layer.

The cathode catalyst layer is not particularly limited as long as it contains a catalyst that contains a catalytic component that exhibits a catalytic action by a reaction (4H⁺+4e⁻→2H₂) in the cathode catalyst layer, and a layer containing a known catalyst can be used. For example, the cathode catalyst layer may be a layer containing a catalyst that contains a support and a catalytic component supported on the support. Examples of the catalyst include Pt, Pt-coated titanium, Pt-supported carbon, Pd-supported carbon, Co (cobalt) glyoxime, and Ni (nickel) glyoxime. The cathode catalyst layer is preferably a layer that contains an ionomer in addition to the catalyst and in which the catalyst is coated with the ionomer. This is because the coatability can be improved and the hydrophilicity of the ionomer enables smooth permeation of the raw water. Examples of the ionomer include an ionomer containing the perfluoro-based electrolyte for use in the solid electrolyte layer.

The membrane electrode assembly is not particularly limited as long as the functional layer of the solid electrolyte membrane and the anode catalyst layer are adjacent to each other. The anode catalyst layer may be applied to the surface of the solid electrolyte membrane near the functional layer, or the anode catalyst layer formed in advance on a separate member may be attached to the surface of the solid electrolyte membrane near the functional layer.

The membrane electrode gas diffusion layer assembly using the membrane electrode assembly includes the anode-side GDL and the cathode-side GDL that sandwich the membrane electrode assembly. The anode-side GDL is not particularly limited and a known member can be used. Examples of the anode-side GDL include a member having gas permeability and electrical conductivity. Specific examples include a porous conductive member made of a sintered body of metal fibers (e.g., titanium fibers) or metal particles (e.g., titanium particles). The cathode-side GDL is not particularly limited and a known member can be used. Examples of the cathode-side GDL include a member having gas permeability and electrical conductivity. Specific examples include a porous conductive member such as carbon cloth or carbon paper. The water electrolysis cell of the water electrolysis device using the membrane electrode gas diffusion layer assembly includes the anode-side separator and the cathode-side separator that sandwich the membrane electrode gas diffusion layer assembly. The anode-side separator and the cathode-side separator are not particularly limited and known separators can be used.

### B. Embodiment of Method for Manufacturing Membrane Electrode Assembly for WE According to Present Disclosure

First, the embodiment of the method for manufacturing the membrane electrode assembly for WE according to the present disclosure will be described based on one exemplary embodiment. The method for manufacturing the membrane electrode assembly for WE according to the embodiment is a mixed production method using a common manufacturing line for the membrane electrode assembly for WE and a membrane electrode assembly for fuel cell (sometimes abbreviated as “FC”), and is a method to be performed to manufacture the membrane electrode assembly for WE by a roll-to-roll process.

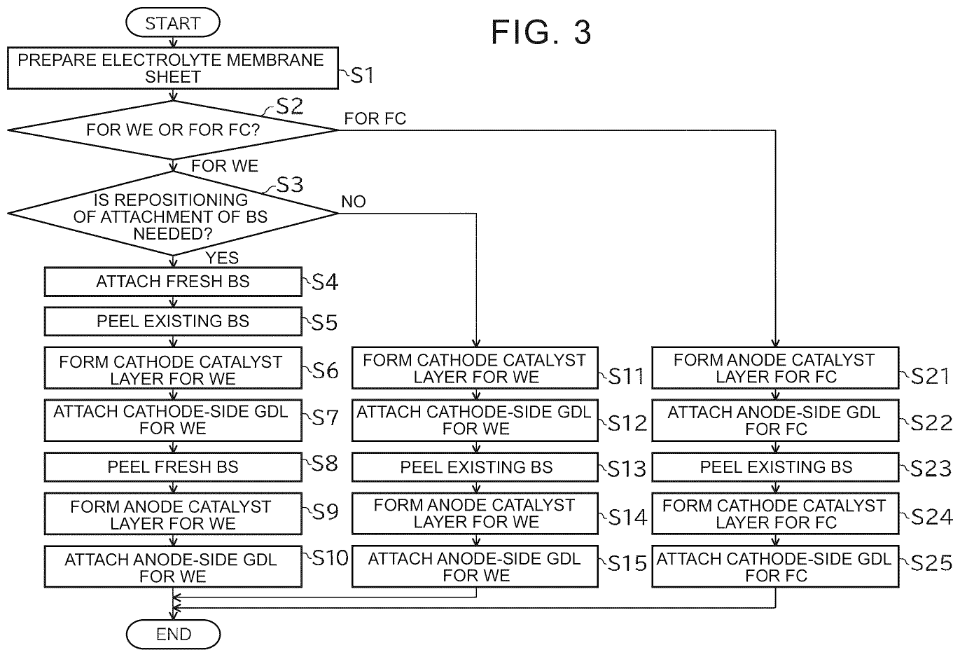

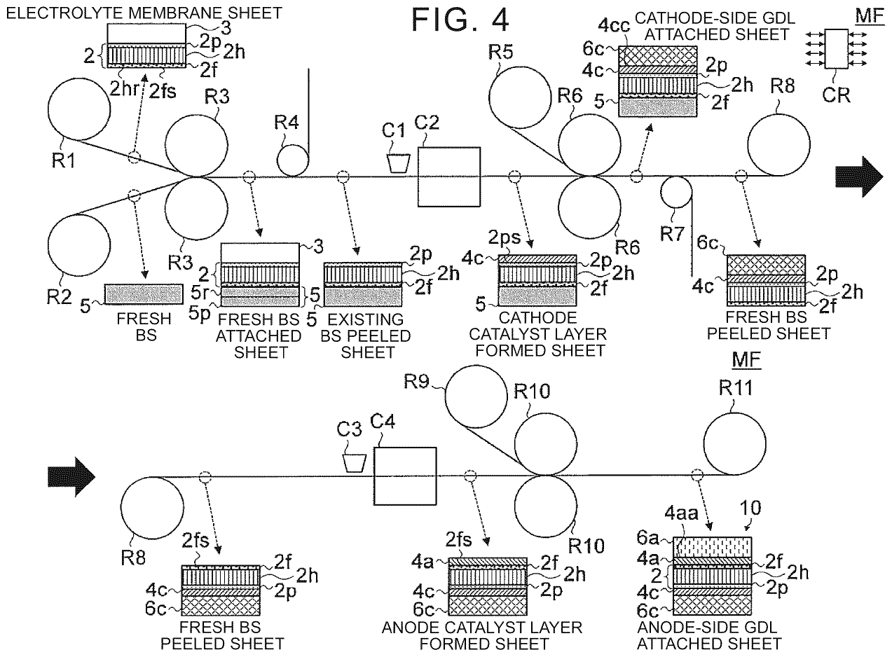

In the mixed production method for implementing the method for manufacturing the membrane electrode assembly according to the embodiment, as shown in FIG. 3, an electrolyte membrane sheet to be used in common for the membrane electrode assembly for WE and the membrane electrode assembly for FC is prepared first (S1). Specifically, an electrolyte membrane sheet roll R1 (FIG. 4) in which an electrolyte membrane sheet is wound into a roll is prepared. The electrolyte membrane sheet (FIG. 4) includes an existing back sheet (sometimes abbreviated as “existing BS”) 3 and the solid electrolyte membrane 2 attached to the existing BS 3. The solid electrolyte membrane 2 includes the solid electrolyte layer 2h, and the functional layer 2f and the resin layer 2p formed on one surface and the other surface of the solid electrolyte layer 2h, respectively. Next, an operator selects the membrane electrode assembly for WE or the membrane electrode assembly for FC as the membrane electrode assembly to be produced (S2).

In the case where the membrane electrode assembly for WE is selected as the membrane electrode assembly to be produced, determination is first made as to whether the attachment of the back sheet (BS) needs to be repositioned when forming the anode catalyst layer 4a on the surface 2fs of the solid electrolyte membrane 2 near the functional layer to produce the membrane electrode assembly 10 for WE according to the embodiment on the common manufacturing line (S3). Specifically, determination is made as to whether the functional layer 2f of the solid electrolyte membrane 2 is formed on the surface 2hr of the solid electrolyte layer 2h opposite to the existing BS in the electrolyte membrane sheet. When the determination is affirmative, determination is made that the attachment of the BS needs to be repositioned. When the determination is negative, determination is made that the attachment of the BS need not be repositioned.

When determination is made that the attachment of the BS needs to be repositioned, a fresh back sheet (sometimes abbreviated as “fresh BS”) 5 is attached (S4). Specifically, as shown in FIG. 4, a fresh BS roll R2 in which the fresh BS 5 is wound into a roll is first prepared in addition to the electrolyte membrane sheet roll R1. The fresh BS 5 is a fresh item including a PET sheet 5p and a release layer 5r formed on the surface of the PET sheet 5p. Next, the electrolyte membrane sheet roll R1 and the fresh BS roll R2 are set on the manufacturing line MF by being disposed on the upper and lower sides to face each other at the most upstream position of the manufacturing line MF. Next, the electrolyte membrane sheet and the fresh BS 5 are sent downstream from the electrolyte membrane sheet roll R1 and the fresh BS roll R2, respectively, such that the surface 2fs of the solid electrolyte membrane 2 of the electrolyte membrane sheet near the functional layer and the surface of the fresh BS 5 near the release layer face each other. Using heating and pressurizing rollers R3 including a pair of rolls with a pressurizing mechanism and a heating mechanism, a laminate is formed by laminating the electrolyte membrane sheet and the fresh BS 5 such that the surface of the fresh BS 5 near the release layer comes into contact with the surface 2fs of the solid electrolyte membrane 2 of the electrolyte membrane sheet near the functional layer between the rolls. The laminate is sandwiched by the rolls. In this state, the rolls are rotated in opposite directions to transport the laminate and pressurize and heat the laminate from both sides in the laminating direction. Thus, the fresh BS 5 (surface near the release layer) is attached to the surface 2fs of the solid electrolyte membrane 2 of the electrolyte membrane sheet near the functional layer by thermocompression bonding, and the sheet after the fresh BS has been attached (sometimes abbreviated as “fresh BS attached sheet”) is transported downstream. At this time, the transport speed of the laminate and the fresh BS attached sheet is preferably, for example, 3 m/min or less.

Next, the existing BS 3 is peeled off (S5). Specifically, as shown in FIG. 4, the existing BS 3 is peeled from the solid electrolyte membrane 2 in the fresh BS attached sheet by an existing BS peeling roller R4, and the sheet after the existing BS has been peeled off (sometimes abbreviated as “existing BS peeled sheet”) is transported downstream.

Next, the cathode catalyst layer 4c for WE is formed (S6). Specifically, as shown in FIG. 4, a cathode catalyst applying device C1 is used to apply a cathode catalyst ink to the surface 2ps of the solid electrolyte membrane 2 of the existing BS peeled sheet near the resin layer (surface opposite to the functional layer), and then a cathode catalyst drying furnace C2 is used to dry the cathode catalyst ink, thereby forming the cathode catalyst layer 4c. The sheet after the cathode catalyst layer has been formed (sometimes abbreviated as “cathode catalyst layer formed sheet”) is transported downstream.

Next, the cathode-side GDL 6c for WE is attached (S7). Specifically, as shown in FIG. 4, the cathode-side GDL 6c is first sent from a cathode-side GDL roll R5 toward cathode-side GDL transfer rollers on the downstream side in synchronization with the transport of the cathode catalyst layer formed sheet. Using cathode-side GDL transfer rollers R6, the cathode-side GDL 6c is attached to the surface 4cc of the cathode catalyst layer formed sheet near the cathode catalyst layer by thermocompression bonding, and the sheet after the cathode-side GDL has been attached (sometimes abbreviated as “cathode-side GDL attached sheet”) is transported downstream.

Next, the fresh BS 5 is peeled off (S8). Specifically, as shown in FIG. 4, the fresh BS 5 is peeled from the solid electrolyte membrane 2 in the cathode-side GDL attached sheet by a fresh BS peeling roller R7, and the sheet after the fresh BS has been peeled off (sometimes abbreviated as “fresh BS peeled sheet”) is transported downstream. Then, as shown in FIG. 4, the fresh BS peeled sheet is wound up by an intermediate product winding roller R8.

Next, the anode catalyst layer 4a for WE is formed (S9). Specifically, as shown in FIG. 4, the fresh BS peeled sheet is first sent downstream from the intermediate product winding roller R8 after the winding has been completed such that the surface 2fs of the solid electrolyte membrane 2 near the functional layer is oriented upward. Then, the fresh BS peeled sheet is transported downstream. Next, an anode catalyst applying device C3 is used to apply an anode catalyst ink to the surface 2fs of the solid electrolyte membrane 2 of the fresh BS peeled sheet near the functional layer, and then an anode catalyst drying furnace C4 is used to dry the anode catalyst ink, thereby forming the anode catalyst layer 4a. The sheet after the anode catalyst layer has been formed (sometimes abbreviated as “anode catalyst layer formed sheet”) is transported downstream.

Next, the anode-side GDL 6a for WE is attached (S10). Specifically, as shown in FIG. 4, the anode-side GDL 6a is first sent from an anode-side GDL roll R9 toward anode-side GDL transfer rollers on the downstream side in synchronization with the transport of the anode catalyst layer formed sheet. Using anode-side GDL transfer rollers R10, the anode-side GDL 6a is attached to the surface 4aa of the anode catalyst layer formed sheet near the anode catalyst layer by thermocompression bonding, and the sheet after the anode-side GDL has been attached (sometimes abbreviated as “anode-side GDL attached sheet”) is transported downstream. Next, as shown in FIG. 4, the anode-side GDL attached sheet that is the membrane electrode gas diffusion layer assembly is wound up by a product winding roller R11. As described above, the manufacturing method (S1 to S10) according to the embodiment is performed in the mixed production method to manufacture the membrane electrode assembly 10 according to the embodiment as part of the membrane electrode gas diffusion layer assembly for WE.

In the above mixed production method, in the determination as to whether the attachment of the BS needs to be repositioned (S3), determination is made as to whether the functional layer 2f of the solid electrolyte membrane 2 is formed on the surface 2hr of the solid electrolyte layer 2h opposite to the existing BS in the electrolyte membrane sheet. When the determination is affirmative, the method for manufacturing the membrane electrode assembly for WE according to the embodiment (S1 to S10) is performed to reposition the attachment of the BS (S4 and S5) and then form the cathode catalyst layer 4c, the cathode-side GDL 6c, the anode catalyst layer 4a, and the anode-side GDL 6a for WE in this order. Thus, the membrane electrode assembly 10 according to the embodiment can be manufactured. When the determination is negative, as shown in FIG. 3, another method for manufacturing the membrane electrode assembly for WE (S1 to S3 and S11 to S15) is performed on the common manufacturing line to form the cathode catalyst layer 4c for WE on the surface 2ps of the solid electrolyte membrane 2 of the electrolyte membrane sheet near the resin layer in step (S11) without repositioning the attachment of the BS (S4 and S5), and then form the cathode-side GDL 6c, the anode catalyst layer 4a, and the anode-side GDL 6a for WE in this order. Thus, the membrane electrode assembly 10 according to the embodiment can be manufactured. When the membrane electrode assembly for FC is selected in the selection of the membrane electrode assembly for WE or the membrane electrode assembly for FC (S2), as shown in FIG. 3, a method for manufacturing the membrane electrode assembly for FC (S1, S2, and S21 to S25) is performed on the common manufacturing line to form an anode catalyst layer, an anode-side GDL, a cathode catalyst layer, and a cathode-side GDL for FC in this order. Thus, the membrane electrode assembly for FC can be manufactured. In the common manufacturing line where the mixed production method is performed, the method for manufacturing the membrane electrode assembly for WE and the method for manufacturing the membrane electrode assembly for FC can share at least the devices C1, C2 that form the cathode catalyst layer (anode catalyst layer for FC), the devices R5, R6 that attach the cathode-side GDL (anode-side GDL for FC), and the devices R9, R10 that attach the anode-side GDL (cathode-side GDL for FC), thereby sharing the order of use of the common devices. The manufacturing method according to the embodiment and the other manufacturing method for the membrane electrode assembly for WE can share, in addition to these devices, the devices C3, C4 that form the anode catalyst layer, thereby sharing the order of use of the common devices.

Therefore, in the mixed production method, the mixed production can be performed on both the membrane electrode assemblies for WE and FC on the common manufacturing line where most of the devices are shared. Even if the functional layer 2f of the solid electrolyte membrane 2 is formed on the surface 2hr of the solid electrolyte layer 2h opposite to the existing BS in the electrolyte membrane sheet, the method for manufacturing the membrane electrode assembly for WE according to the embodiment (S1 to S10) is performed. Thus, the membrane electrode assembly 10 according to the embodiment in which the anode catalyst layer 4a is formed on the surface 2fs of the solid electrolyte membrane 2 near the functional layer can be manufactured on the manufacturing line shared with the other method for manufacturing the membrane electrode assembly for WE. Therefore, the membrane electrode assembly 10 that can improve the blocking performance against the permeation of hydrogen gas through the solid electrolyte membrane 2 and suppress the generation of oxyhydrogen gas can be manufactured efficiently and inexpensively.

Hereinafter, the embodiment of the method for manufacturing the membrane electrode assembly for WE according to the present disclosure will further be described.

The preparation step is not particularly limited as long as the electrolyte membrane sheet is prepared. The existing BS of the electrolyte membrane sheet is not particularly limited as long as it includes a base sheet (e.g., a polyethylene terephthalate (PET) sheet), and examples thereof include a sheet that further includes a release layer formed on the surface of the base sheet.

The attachment step is not particularly limited, and is preferably a step in which the heating temperature when heating the laminate while pressurizing it from both sides in the laminating direction is 120° C. or more and a thermal decomposition temperature or less, and more preferably a step in which the heating temperature is 120° C. or more and 130° C. or less. The “heating temperature” refers to a temperature of a heating member that heats the laminate, such as a pair of rolls with a heating mechanism. The “thermal decomposition temperature” refers to a heating temperature at which the material of the solid electrolyte membrane is decomposed. In the attachment step, the surface of the fresh BS to be attached to the solid electrolyte membrane may be either the surface near the PET sheet or the surface near the release layer. The attachment step may be, for example, the step (S4) according to the embodiment. The fresh BS preferably has a width (width perpendicular to the feeding direction of the fresh BS roll) equal to or more than the width of the solid electrolyte membrane of the electrolyte membrane sheet (width perpendicular to the feeding direction of the electrolyte membrane sheet roll). This is because the solid electrolyte membrane can be prevented from sticking to the rollers that transport the solid electrolyte membrane. The fresh BS may be, for example, the same as the existing BS, and may also be a fresh item (fresh purchased BS) or a reused item (reused peeled BS).

The existing BS peeling step is not particularly limited, and may be a step of peeling the existing back sheet from the solid electrolyte membrane while attaching a fresh back sheet to the surface of the solid electrolyte membrane near the functional layer in the attachment step, or a step of peeling the existing back sheet from the solid electrolyte membrane after the attachment step.

Hereinafter, the membrane electrode assembly for WE and the method for manufacturing the membrane electrode assembly for WE according to the embodiment will be described in more detail based on Example, Comparative Examples, and Reference Examples.

### 1. Membrane Electrode Assembly

An example of the membrane electrode assembly for WE according to the embodiment was fabricated in accordance with the following procedure. At this time, the hydrogen permeability of a single piece of the solid electrolyte membrane used in the membrane electrode assembly was measured. A water electrolysis cell was then fabricated from the membrane electrode assembly, and a water electrolysis experiment was conducted using the water electrolysis cell.

### Membrane Electrode Assembly Fabrication Procedure

First, the anode catalyst layer was formed. At this time, 48.0 g of an anode catalyst (iridium oxide catalyst (produced by Umicore)), 9.6 g of an ionomer having proton conductivity (produced by AGC Inc.), 36.0 g of deionized water, and 54.7 g of alcohol (21.5 g of 1-propanol and 33.2 g of ethanol) were first mixed in a beaker and dispersed using an ultrasonic homogenizer to obtain a catalyst ink. Next, the catalyst ink was applied to the surface of a base sheet (Teflon (registered trademark) sheet, thickness: 1.0 mm) using an applicator. Next, the catalyst ink was dried at 85° C. for 5 minutes to form the anode catalyst layer (thickness: about 2 μm).

Next, the cathode catalyst layer was formed. At this time, 6.1 g of a cathode catalyst (Pt-supported carbon (Pt support amount of 18%, produced by Cataler Corporation)), 6.0 g of an ionomer having proton conductivity (produced by AGC Inc.), 88.4 g of deionized water, and 45.2 g of alcohol (ethanol) were first mixed in a beaker and dispersed using an ultrasonic homogenizer to obtain a catalyst ink. Next, the catalyst ink was applied to the surface of a base sheet (Teflon (registered trademark) sheet, thickness: 1.0 mm) using an applicator. Next, the catalyst ink was dried at 85° C. for 5 minutes to form the cathode catalyst layer (thickness: about 6 μm).

Next, a solid electrolyte membrane (Membrane (M775.15) produced by Gore, thickness: about 15 μm) attached to an existing BS was prepared. The solid electrolyte membrane includes a solid electrolyte layer (thickness: about 3 μm), and a functional layer (thickness: about 6 μm) and a resin layer (thickness: about 6 μm) formed on one surface and the other surface of the solid electrolyte layer, respectively. The solid electrolyte layer is expanded polytetrafluoroethylene (ePTFE). The functional layer contains a resin (perfluorosulfonic acid polymer), supports (carbon supports) dispersed in the resin, and catalytic metal particles (platinum metal) supported on the supports. The resin layer contains a resin (perfluorosulfonic acid polymer). Next, the existing BS was peeled from the solid electrolyte membrane. As shown in FIGS. 1A and 1B, the anode catalyst layer was disposed on the surface of the solid electrolyte membrane near the functional layer and the cathode catalyst layer was disposed on the surface of the solid electrolyte membrane near the resin layer such that the anode catalyst layer and the cathode catalyst layer were adjacent to the functional layer and the resin layer of the solid electrolyte membrane, respectively. Then, the base sheets were peeled from these catalyst layers, and the resultant was hot pressed at 130° C. and 130 kPa for 4 minutes or more. Thus, the membrane electrode assembly was fabricated.

### Procedure for Measuring Hydrogen Permeability of Single Piece of Solid Electrolyte Membrane

For a single piece of the prepared solid electrolyte membrane, the hydrogen permeability [cc/m²·24 hr·atm] was measured at a measurement temperature of 55° C. and at each relative humidity [% RH] by an isobaric method using a gas permeability measuring device (manufactured by GTR TEC Corporation).

### Water Electrolysis Cell Fabrication Procedure

On the membrane electrode assembly, an anode-side GDL (Pt-deposited titanium fiber) and an anode-side separator were laminated in this order on the surface of the anode catalyst layer opposite to the solid electrolyte membrane, and a cathode-side GDL (carbon fiber) and a cathode-side separator were laminated in this order on the surface of the cathode catalyst layer opposite to the solid electrolyte membrane. The obtained laminate was pressed to fabricate a water electrolysis cell.

### Water Electrolysis Experiment Procedure

A sufficient amount of pure water (raw water) was supplied to the water electrolysis cell from the water supply port of the anode-side separator. At the same time, the temperature of the water electrolysis cell was raised to 60° C. A voltage was applied between the anode-side separator and the cathode-side separator such that the electrolysis current density was 2.5 A/cm², and water electrolysis was performed for 5 hours. Gas generated from the anode side during the water electrolysis was collected using a sampling bag, and gas components were analyzed by mass spectrometry to measure the amount of hydrogen in the gas generated on the anode side.

### Comparative Example 1

A membrane electrode assembly was fabricated through the same procedure as in Example, except that, during the hot pressing, the existing BS was peeled from the solid electrolyte membrane, the cathode catalyst layer was disposed on the surface of the solid electrolyte membrane near the functional layer and the anode catalyst layer was disposed on the surface of the solid electrolyte membrane near the resin layer as shown in FIGS. 2A and 2B such that the cathode catalyst layer and the anode catalyst layer were adjacent to the functional layer and the resin layer of the solid electrolyte membrane, respectively, the base sheets were then peeled from these catalyst layers, and the resultant was hot pressed. A water electrolysis cell was then fabricated from the membrane electrode assembly through the same procedure as in Example, and a water electrolysis experiment was conducted using the water electrolysis cell through the same procedure as in Example.

### Comparative Example 2

When preparing the solid electrolyte membrane, a solid electrolyte membrane including a solid electrolyte layer and resin layers formed on one surface and the other surface of the solid electrolyte layer was prepared. The solid electrolyte layer and the resin layers are the same as the solid electrolyte layer and the resin layer in the solid electrolyte membrane of Example. During the hot pressing, the existing BS was peeled from the solid electrolyte membrane, the anode catalyst layer and the cathode catalyst layer were disposed on one surface and the other surface of the solid electrolyte membrane such that the anode catalyst layer and the cathode catalyst layer were adjacent to the resin layers on both sides of the solid electrolyte membrane, the base sheets were then peeled from these catalyst layers, and the resultant was hot pressed. A membrane electrode assembly was fabricated through the same procedure as in Example except for these points. At this time, the hydrogen permeability of a single piece of the prepared solid electrolyte membrane was measured through the same procedure as in Example. A water electrolysis cell was then fabricated from the membrane electrode assembly through the same procedure as in Example, and a water electrolysis experiment was conducted using the water electrolysis cell through the same procedure as in Example.

### Evaluation

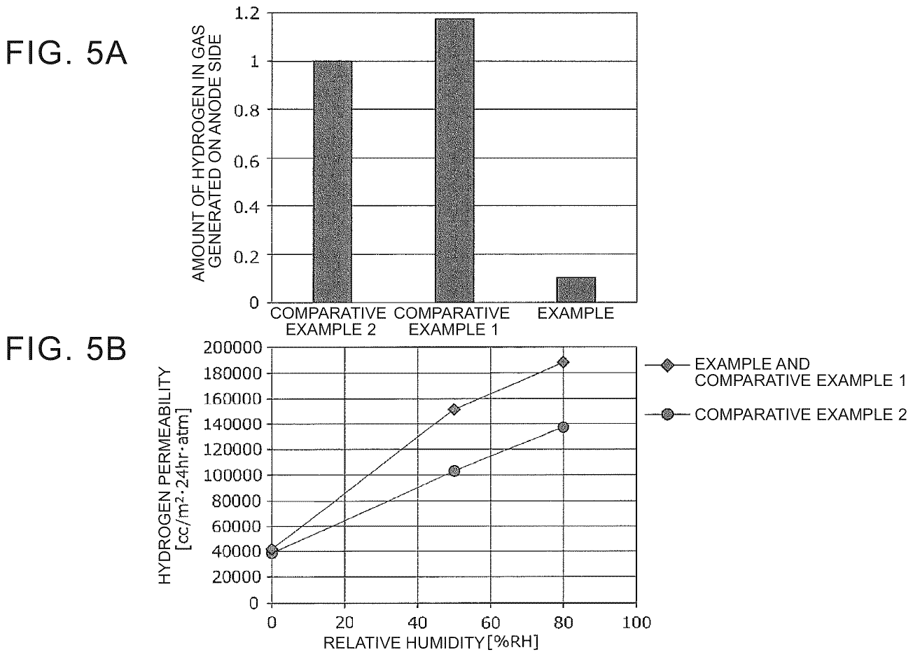

As shown in FIG. 5B, the solid electrolyte membranes prepared for the membrane electrode assemblies of Example and Comparative Example 1 have, as single pieces, higher hydrogen permeabilities at each relative humidity than the solid electrolyte membrane prepared for the membrane electrode assembly of Comparative Example 2, and are more likely to allow hydrogen gas to permeate them. Despite this fact, as shown in FIG. 5A, the water electrolysis experiment using the water electrolysis cell fabricated from the membrane electrode assembly of Example demonstrates that the amount of hydrogen in the gas generated on the anode side was specifically reduced to show good results in comparison with not only the water electrolysis experiment using the water electrolysis cell fabricated from the membrane electrode assembly of Comparative Example 1, but also the water electrolysis experiment using the water electrolysis cell fabricated from the membrane electrode assembly of Comparative Example 2. The reason why the membrane electrode assembly of Example shows good results exhibiting specific hydrogen blocking properties may be as follows. The anode catalyst layer was adjacent to the functional layer of the solid electrolyte membrane, and an interaction occurred between the catalyst in the anode catalyst layer and the functional layer. When hydrogen gas was to permeate the solid electrolyte membrane from the cathode side and flow back to the anode side, the hydrogen gas was converted into hydrogen ions (H⁺) or water (H₂O) by the interaction, thereby blocking the permeation of hydrogen itself.

### 2. Method for Manufacturing Membrane Electrode Assembly

### Reference Example 1

In accordance with the following procedure, the main steps of one example of the method for manufacturing the membrane electrode assembly for WE according to the embodiment were performed to fabricate an existing BS peeled sheet (sheet after the existing BS has been peeled off).

First, an electrolyte membrane sheet roll in which an electrolyte membrane sheet was wound into a roll was prepared. The electrolyte membrane sheet includes an existing BS and a solid electrolyte membrane attached to the existing BS. The solid electrolyte membrane includes a solid electrolyte layer, and a functional layer and a resin layer formed on one surface and the other surface of the solid electrolyte layer, respectively. The resin layer and the functional layer are disposed near the existing BS and opposite to the existing BS in the solid electrolyte membrane, respectively. Further, a fresh BS roll in which a fresh back sheet (fresh BS) was wound into a roll was prepared. The fresh BS is a fresh item including a PET sheet and a release layer containing a cycloolefin copolymer and formed on the surface of the PET sheet.

Next, the electrolyte membrane sheet roll and the fresh BS roll were disposed on the upper and lower sides to face each other. Next, the electrolyte membrane sheet and the fresh BS were sent downstream from the electrolyte membrane sheet roll and the fresh BS roll, respectively, such that the surface of the solid electrolyte membrane of the electrolyte membrane sheet near the functional layer and the surface of the fresh BS near the PET sheet faced each other. Using heating and pressurizing rollers including a pair of rolls with a pressurizing mechanism and a heating mechanism, a laminate was formed by laminating the electrolyte membrane sheet and the fresh BS such that the surface of the fresh BS near the PET sheet came into contact with the surface of the solid electrolyte membrane of the electrolyte membrane sheet near the functional layer between the rolls. The laminate was sandwiched by the rolls. In this state, the rolls were rotated in opposite directions to transport the laminate and pressurize and heat the laminate from both sides in the laminating direction. Thus, the fresh BS (surface near the PET sheet) was attached to the surface of the solid electrolyte membrane of the electrolyte membrane sheet near the functional layer by thermocompression bonding to form the fresh BS attached sheet, and the fresh BS attached sheet was transported downstream. Next, the existing BS was peeled from the solid electrolyte membrane of the electrolyte membrane sheet in the fresh BS attached sheet by an existing BS peeling roller, and the existing BS peeled sheet was transported downstream. Next, the existing BS peeled sheet was wound up by a winding roller. In this way, the existing BS peeled sheet was fabricated. In this case, the heating temperature [° C.], the pressurizing force [MPa], and the transport speed [m/min] during the thermocompression bonding were set as shown in Table 1.

### Reference Examples 2 to 10

In Reference Examples 2 to 10, existing BS peeled sheets were fabricated in the same way as in Reference Example 1, except for some conditions. Specifically, in Reference Examples 2 to 10, either a fresh item similar to that in Reference Example 1 or a reused item was used as the fresh BS as shown in Table 1. As shown in Table 1, the fresh BS roll was changed such that the surface of the fresh BS attached to the solid electrolyte membrane was either the surface near the PET sheet or the surface near the release layer. Further, the heating temperature [° C.], the pressurizing force [MPa], and the transport speed [m/min] during the thermocompression bonding were set as shown in Table 1. The existing BS peeled sheets were fabricated in the same way as in Reference Example 1, except for these conditions.

TABLE 1

| | | Surface of fresh | Heating | Pressur- | Trans- |
|---|---|---|---|---|---|
| | | BS attached to | temper- | izing | port |
| | Fresh BS | solid electrolyte | ature | force | speed |
| | type | membrane | [° C.] | [MPa] | [m/min] |
| Reference | Fresh | Surface near | 90 | 0.5 | 0.5 |
| Example 1 | item | PET sheet | | | |
| Reference | Fresh | Surface near | 90 | 0.5 | 0.5 |
| Example 2 | item | release layer | | | |
| Reference | Fresh | Surface near | 110 | 0.5 | 0.5 |
| Example 3 | item | PET sheet | | | |
| Reference | Fresh | Surface near | 120 | 0.5 | 0.5 |
| Example 4 | item | PET sheet | | | |
| Reference | Fresh | Surface near | 130 | 0.5 | 0.5 |
| Example 5 | item | PET sheet | | | |
| Reference | Reused | Surface near | 130 | 0.5 | 0.5 |
| Example 6 | item | release layer | | | |
| Reference | Reused | Surface near | 130 | 0.5 | 0.5 |
| Example 7 | item | PET sheet | | | |
| Reference | Fresh | Surface near | 130 | 0.5 | 3.0 |
| Example 8 | item | PET sheet | | | |
| Reference | Reused | Surface near | 130 | 0.5 | 3.0 |
| Example 9 | item | release layer | | | |
| Reference | Reused | Surface near | 130 | 0.5 | 3.0 |
| Example 10 | item | PET sheet | | | |

### Fresh BS Peel Test

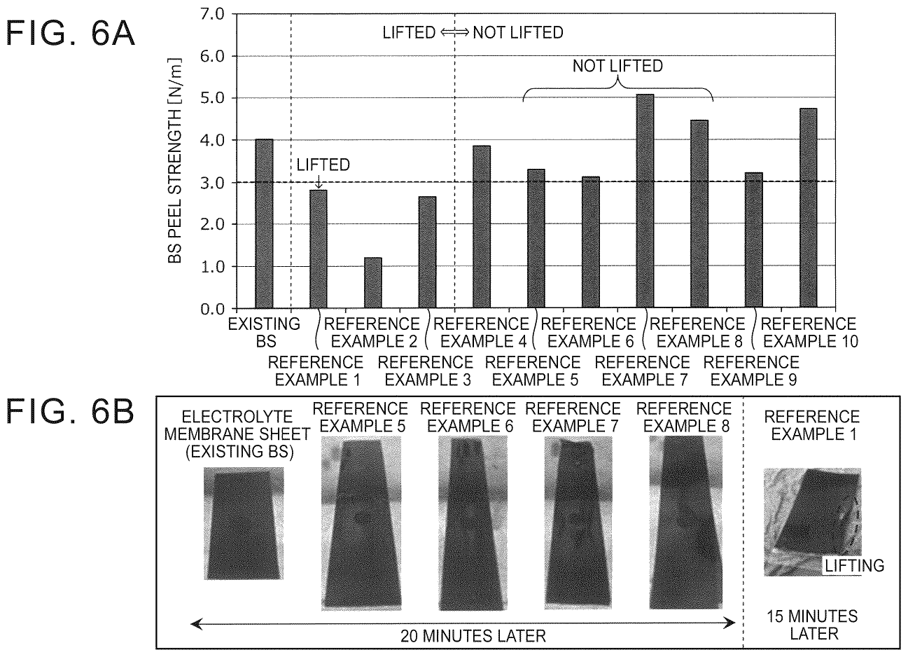

A peel test was conducted on the existing BS peeled sheets of Reference Examples 1 to 10 to determine the peel strength of the fresh BS. In this case, a sample of a predetermined size was first cut out from the existing BS peeled sheet of each example. Next, a 90-degree peel test was conducted using an autograph to peel the fresh BS from the solid electrolyte membrane of each sample, and the peel strength of the fresh BS was determined. As shown in FIG. 6A, the peel strength of the existing BS was 4 N/m, whereas the peel strength of the fresh BS of Reference Examples 1 to 10 was 1.2 N/m to 5.1 N/m.

### Fresh BS Lifting Check Test

For the existing BS peeled sheet of Reference Example 1 in which the peel strength of the fresh BS was 2.8 N/m and the existing BS peeled sheets of Reference Examples 5 to 8 in which the peel strength of the fresh BS was 3.1 N/m to 5.1 N/m, a fresh BS lifting check test was conducted to evaluate the effect of the solvent on the fresh BS when applying the catalyst ink to form the catalyst layer on the surface of the solid electrolyte membrane. In this case, a sample of a predetermined size was first cut out from the existing BS peeled sheet of each example. Next, deionized water and ethanol were mixed at a mass ratio of 1:1 to prepare a mixed solvent. Next, one drop of the mixed solvent collected with a dropper was put onto the surface of the solid electrolyte membrane of the sample of each example opposite to the fresh BS. Next, the sample of each example was observed over time to check whether the fresh BS was lifted.

As shown in FIG. 6B, in the samples of the existing BS peeled sheets of Reference Examples 5 to 8 in which the peel strength of the fresh BS was 3.1 N/m to 5.1 N/m, the fresh BS was still attached to the solid electrolyte membrane even after an elapse of 20 minutes from the dropping of the mixed solvent. It is considered that, though the mixed solvent penetrated the solid electrolyte membrane and accumulated at the interface between the solid electrolyte membrane and the fresh BS, the adhesion between the solid electrolyte membrane and the fresh BS was strong and therefore the fresh BS was not peeled off. That is, it is considered that the existing BS peeled sheets of Reference Examples 5 to 8 were able to achieve sufficient adhesion between the solid electrolyte membrane and the fresh BS. In the sample of the existing BS peeled sheet of Reference Example 1 in which the peel strength of the fresh BS was 2.8 N/m, lifting of the fresh BS was observed after an elapse of 15 minutes from the dropping of the mixed solvent. It is considered that, due to low adhesion between the solid electrolyte membrane and the fresh BS, the mixed solvent penetrated the solid electrolyte membrane and accumulated at the interface between the solid electrolyte membrane and the fresh BS, and the fresh BS was peeled off. As shown in the leftmost part of FIG. 6B, in the electrolyte membrane sheet sample, the existing BS was still attached to the solid electrolyte membrane even after an elapse of 20 minutes from the dropping of the mixed solvent.

### Evaluation

From the above test results, it is considered that, when the peel strength of the fresh BS is 3 N/m or more as in the case of the existing BS peeled sheets of Reference Examples 5 to 8, the fresh BS is not lifted due to the effect of the solvent during the application of the catalyst ink, and mass production of membrane electrode assemblies will be possible. It is considered that, when the peel strength of the fresh BS is less than 3 N/m as in the case of the existing BS peeled sheet of Reference Example 1, the fresh BS may be lifted due to the effect of the solvent during the application of the catalyst ink, and the mass production of membrane electrode assemblies will be difficult. It is considered that, when the heating temperature during the thermocompression bonding is 120° C. or more and the thermal decomposition temperature or less, the peel strength of the fresh BS will be 3 N/m or more regardless of whether the fresh BS is a fresh item and regardless of whether the surface of the fresh BS attached to the solid electrolyte membrane is the surface near the PET sheet or the surface near the release layer. Therefore, it is considered that, when the heating temperature during the thermocompression bonding is 120° C. or more and the thermal decomposition temperature or less, sufficient adhesion can be achieved by attaching the fresh BS to the solid electrolyte membrane.

Although the embodiments of the membrane electrode assembly and the method for manufacturing the membrane electrode assembly according to the present disclosure are described in detail above, the disclosure is not limited to the embodiments described above, and various design changes can be made without departing from the spirit of the disclosure described in the claims.

What is claimed is:

1. A membrane electrode assembly for water electrolysis, the membrane electrode assembly comprising a solid electrolyte membrane, and an anode catalyst layer and a cathode catalyst layer that sandwich the solid electrolyte membrane, wherein
the solid electrolyte membrane includes a solid electrolyte layer, and a functional layer provided on an anode-side surface of the solid electrolyte layer,
the anode catalyst layer is provided on a surface of the solid electrolyte membrane near the functional layer,
the cathode catalyst layer is provided on a surface of the solid electrolyte membrane opposite to the functional layer, and
the functional layer contains a resin and catalytic metal particles dispersed in the resin.

2. The membrane electrode assembly according to claim 1, wherein the catalytic metal particles contain one or more kinds selected from the group consisting of Pt, Au, Pd, Rh, and Ir.

3. A method for manufacturing a membrane electrode assembly for water electrolysis, the method comprising:
preparing an electrolyte membrane sheet including an existing back sheet and a solid electrolyte membrane attached to the existing back sheet, the solid electrolyte membrane including a solid electrolyte layer and a functional layer provided on a surface of the solid electrolyte layer opposite to the existing back sheet;
attaching a fresh back sheet to a surface of the solid electrolyte membrane near the functional layer through thermocompression bonding by laminating the electrolyte membrane sheet and the fresh back sheet to form a laminate such that the fresh back sheet is in contact with the surface of the solid electrolyte membrane near the functional layer, and heating the laminate while pressurizing the laminate from both sides in a laminating direction;
peeling the existing back sheet from the solid electrolyte membrane;
forming a cathode catalyst layer on a surface of the solid electrolyte membrane opposite to the functional layer after the peeling of the existing back sheet;
peeling the fresh back sheet from the solid electrolyte membrane after the forming of the cathode catalyst layer; and
forming an anode catalyst layer on the surface of the solid electrolyte membrane near the functional layer after the peeling of the fresh back sheet.

4. The method for manufacturing the membrane electrode assembly according to claim 3, wherein, in the attaching, a heating temperature when heating the laminate while pressurizing the laminate from both the sides in the laminating direction is 120° C. or more and a thermal decomposition temperature or less.
